(19) United States
(12) Patent Application Publication
(10) Pub. No.: US 2007/0181022 A1
(43) Pub. Date: Aug. 9, 2007

(54) Apparatus and method for controlling the supply of fluid

(75) Inventor: Martin Mayer, Ladenburg (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/649,386

(22) Filed: Jan. 3, 2007

(30) Foreign Application Priority Data
Feb. 6, 2006 (DE) 10 2006 005 174.2

(51) Int. Cl. B41F 31/00

(52) U.S. Cl. 101/349.1

(57) ABSTRACT

An apparatus for controlling the amount of fluid to be transferred, contains a first rotating device which has a first fluid-transferring section in its circumferential direction, a second rotating device which has a second fluid-transferring section in its circumferential direction, and a control device for setting the phase position between the first fluid-transferring section and the second fluid-transferring section. The control device is configured for accelerating and retarding a rotation of the first rotating device periodically.

### CROSS-REFERENCE TO RELATED APPLICATION

This application claims the priority, under 35 U.S.C. §119, of German application DE 10 2006 005 174.2, filed Feb. 6, 2006; the prior application is herewith incorporated by reference in its entirety.

### BACKGROUND OF THE INVENTION

### Field of the Invention

The present invention relates to an apparatus for controlling the supply of fluid, for example for controlling the supply of ink or dampening solution in a printing press. The apparatus contains a first rotating device which has a first fluid-transferring section in its circumferential direction, a second rotating device which has a second fluid-transferring section in its circumferential direction, and a control device for setting the phase position between the first fluid-transferring section and the second fluid-transferring section.

Furthermore, the present invention relates to a method for controlling the supply of fluid.

A wide variety of apparatuses and methods for transferring a fluid in printing processes, in particular a lithographic fluid such as ink or dampening solution during offset printing, from a supply unit, for example an ink fountain roller or a dampening solution fountain roller, to a following unit, for example an inking unit roller or a dampening unit roll, are known from the prior art. It is to be noted here that printing ink, even if it has more or less pasty properties, is denoted as and considered to be a fluid in the following text.

The supplied amount of fluids of this type can usually be controlled, in order for it to be possible to change a film thickness to be produced of the fluid on the units which follow, for example the roller surfaces, in accordance with the print job.

Published, non-prosecuted German patent application DE 10 2004 005 578 A1, corresponding to U.S. Pat. No. 6,789,478 B1, discloses an apparatus which corresponds to the generic type which is mentioned in the introduction. When this apparatus of the prior art is used in a printing press which runs at a high machine speed, all of the rollers and cylinders of the apparatus rotate at a high speed. As a result, small air bubbles and foam are formed in an ink supply of the apparatus, which in turn reduces the printing quality. Moreover, hydrodynamic forces of the printing ink result from the high printing speed, which hydrodynamic forces act on a pre-metering device of the apparatus and reduce the metering accuracy.

### SUMMARY OF THE INVENTION

It is accordingly an object of the invention to provide an apparatus and a method for controlling the supply of fluid which overcome the above-mentioned disadvantages of the prior art devices and methods of this general type, in which more accurate fluid metering is possible and improved printing quality can be achieved.

An apparatus according to the invention for controlling the amount to be transferred of a fluid contains a first rotating apparatus having a first fluid-transferring section on the circumference, a second rotating apparatus having a second fluid-transferring section on the circumference, and a control device for setting the phase between the first fluid-transferring section and the second fluid-transferring section. The invention is characterized in that the control device is configured for accelerating and retarding the rotation of the first rotating apparatus periodically.

An apparatus according to the invention of this type is preferably used in an inking unit or a dampening unit of a machine which processes printing material, for example a sheet-fed or web-fed offset printing press. Here, the apparatus according to the invention preferably serves for the controllable transfer of printing ink or dampening solution.

Instead of the term “transfer”, the term “supply” can also be used here, as the transfer of the fluid from a unit which is disposed in front to a unit which is disposed behind ultimately equates to the supply of the fluid to the unit which is disposed behind.

The fluid can be transferred precisely and with high constancy as a result of the ability to set the phase between the first fluid-transferring section and the second fluid-transferring section, as the overlapping sheet length of the first apparatus and the second apparatus, for example rollers, can be controlled exactly in a simple way, because the fluid is transferred only in the region of the overlapping sheet length.

The relative phase position can be set during pre-setting or else during continuous printing, in order to correct the amount of fluid to be transferred.

The first rotating apparatus preferably contains a first non-transferring section which is disposed remote from the first fluid-transferring section in a circumferential direction, and the second rotating apparatus preferably contains a second non-transferring section which is disposed remote from the second fluid-transferring section in a circumferential direction.

Therefore, if fluid from the first fluid-transferring section passes into the region of the second non-transferring section, this fluid is not received and transferred by the second rotating apparatus.

The first fluid-transferring section and the first non-transferring section preferably have the same circumferential extent or sheet length as the second fluid-transferring section and the second non-transferring section.

The first fluid-transferring section and/or the second fluid-transferring section can preferably protrude in the manner of a relief, and/or the first non-fluid transferring section and/or the second non-fluid-transferring section can be recessed in the manner of a relief. At least one height difference between the fluid-transferring sections and the non-fluid-transferring sections is preferably provided.

The non-transferring function of the first non-transferring section and/or the second non-transferring section is achieved advantageously in an effective and simple manner by the depression. The depression of the first non-transferring section and/or the second non-transferring section can be deeper than the thickness of a fluid film on the first fluid-transferring section and/or the second fluid-transferring section, and is preferably a multiple of this thickness.

The first fluid-transferring section and/or the second fluid-transferring section preferably define/defines a bent rectangle or are/is configured in the shape of a helical section.

The first fluid-transferring section or the second fluid-transferring section preferably is formed of an elastically deformable material, for example a natural or artificial rubber material, while the fluid-transferring section of the section which interacts with the former is formed of a rigid material, for example is made from metal, plastic or ceramic.

The first non-fluid-transferring section and/or the second non-fluid-transferring section can be formed by a cutout which is provided in the elastically deformable material.

Furthermore, the first non-fluid-transferring section and/or the second non-fluid-transferring section can be formed by a cutout which is provided in the substantially dimensionally stable material.

The first fluid-transferring section can have an oleophilic surface which receives ink. The first non-transferring section can have a fluid-rejecting surface which rejects the fluid, the oleophobic surface being oleophobic and/or hydrophilic.

A synchronized nip which is repeated, for example during every revolution of the rotating apparatuses, can be defined between the first rotating apparatus and the second rotating apparatus. The nip can be disposed, for example, between the first fluid-transferring section and the second non-transferring section.

The first rotating apparatus and/or the second rotating apparatus are/is preferably configured as a roller or cylinder, that is to say a first cylinder and a second cylinder can be provided, the first cylinder having a first diameter and the second cylinder having a second diameter. The ratio of the two diameters with respect to one another is an integral number, for example 1 or 2. The first cylinder and the second cylinder preferably have substantially the same diameter or a diameter which is substantially an integral multiple.

In order to transfer the fluid with a uniform film thickness onto the first rotating device, a system can be provided containing a roller and a chamber-type doctor, in particular an engraved roller or anilox roller, or a system can be provided containing a roller and a spraying apparatus, or a system can be provided containing a fluid fountain having a zone blade and a roller, or a fluid jet system, in particular an inkjet system.

The fluid can be printing ink, dampening solution or varnish.

The present invention also contains an inking unit for controlling the supplied amount of ink, having a first rotating apparatus with a first ink-transferring section in the circumferential direction, a second rotating apparatus with a second ink-transferring section, and a control device for setting the phase position between the first ink-transferring section and the second ink-transferring section, which inking unit is characterized in that the control device is configured for accelerating and retarding the rotation of the first rotating apparatus periodically.

A dampening unit according to the invention for controlling the supplied amount of dampening solution contains a first rotating apparatus with a first dampening-agent-transferring section in the circumferential direction, a second rotating apparatus with a second dampening-agent-transferring section, and a control device for setting the phase position between the first dampening-agent-transferring section and the second dampening-agent-transferring section. The invention is characterized in that the control device is configured for accelerating and retarding the rotation of the first rotating apparatus periodically.

A machine according to the invention which processes printing material contains an apparatus for controlling the transfer of an amount of fluid, having the described features.

A method according to the invention for controlling the supplied amount of fluid provides for a fluid of a first rotating apparatus with a first fluid-transferring section in the circumferential direction to be supplied, for at least one part of the fluid to be transferred onto a second rotating apparatus with a second fluid-transferring section in the circumferential direction, for the transferred portion to be controlled by the setting of the phase position between the first fluid-transferring section and the second fluid-transferring section, and for the rotation of the first rotating apparatus to be accelerated and retarded periodically. Here, the overlapping sheet length can be set between the first fluid-transferring section and the second fluid-transferring section.

Other features which are considered as characteristic for the invention are set forth in the appended claims.

Although the invention is illustrated and described herein as embodied in an apparatus and a method for controlling the supply of fluid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic illustration of one embodiment of an inking unit according to the invention, in which the rotating apparatuses are not phase-shifted with respect to one another; and

FIG. 2 is a diagrammatic illustration of the embodiment shown in FIG. 1, with a phase shift of 45° between the rotating apparatuses.

### DESCRIPTION OF THE PREFERRED EMBODIMENTS

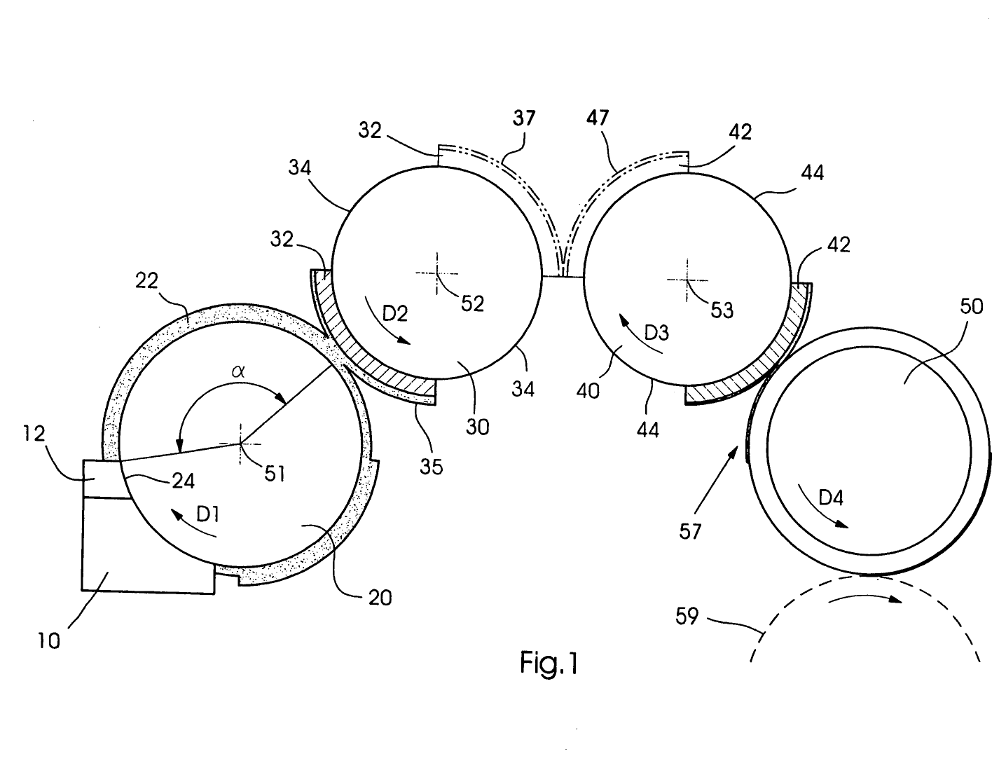

Referring now to the figures of the drawing in detail and first, particularly, to FIG. 1 thereof, there is shown one preferred embodiment of an ink supply apparatus according to the invention, in which the rotating apparatuses are configured as cylinders.

A feed roller 20 rotates in a direction D1 and in the process receives ink from an ink supply 10. The ink supply 10 can have a pre-metering device 12, for example a doctor. In this way, a uniform, pre-metered ink film is applied onto an outer circumferential surface 24 of the feed roller 20. Although the ink supply 10 in the example shown is configured as an ink fountain having a continuous doctor 12, an anilox roller or an anilox inking unit, a roller with a spraying apparatus, an ink fountain system having zone blades, an inkjet system or another apparatus for supplying a pre-metered film 22 can also be provided.

The ink supply apparatus contains, furthermore, a first rotating apparatus which is configured in the present preferred embodiment as an ink-transferring cylinder 30 which rotates in a direction D2 and has an ink-transferring section 32 and a non-transferring section 34 as viewed in the circumferential direction. In the embodiment which is shown, the ink-transferring section 32 is a radially protruding deformable section which is configured, for example, as a rubber coating on a metal cylinder body. A rubber outer surface of this type makes satisfactory ink transfer possible.

The non-transferring section 34 can be configured simply as a section of the metal cylinder body which is not coated with the radially protruding rubber coating and is therefore depressed radially with regard to the ink-transferring section 32 of the cylinder 30 with a greater diameter. As an alternative, the non-transferring section 34 can also be formed by a circumferential section of a metal cylinder which is coated with rubber overall being removed. On account of the depression, the feed roller 20 does not transfer any ink onto the non-transferring section 34, while an ink film 35 is produced on the ink-transferring section 32 by ink splitting.

A second ink-transferring cylinder 40 with an ink-transferring circumferential section 42 and a non-transferring circumferential section 44 interacts with the ink-transferring cylinder 30. The ink-transferring section preferably contains an ink-transferring coating which is hard, that is to say substantially non-deformable, for example made from metal, plastic or ceramic, and protrudes radially with regard to the cylinder body.

Here, the non-transferring section 44 can be configured simply from a section which is not coated with the hard, radially protruding coating and is radially depressed in this way with regard to the surface which is defined by the ink-transferring section 42 with a greater diameter. As an alternative, the non-transferring section 44 can also be formed by a circumferential section of a cylinder which is coated with ceramic, metal or plastic being removed.

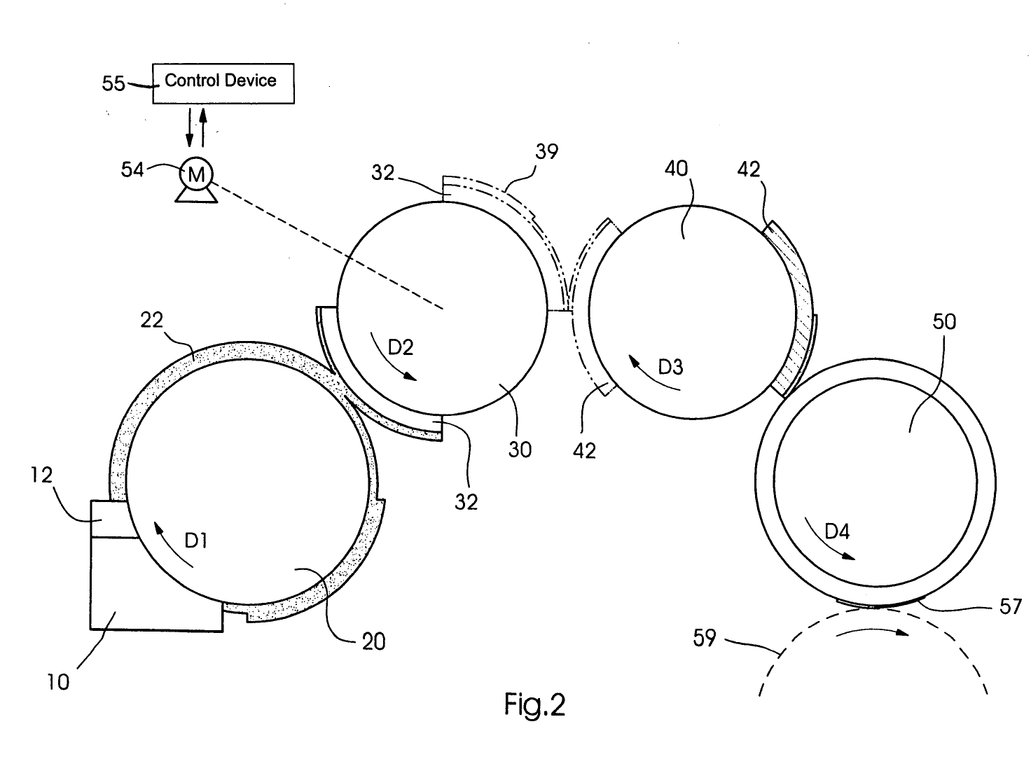

In order to transfer ink from the cylinder 30 onto the cylinder 40, which transfer is shown in FIGS. 1 and 2 with a phantom line, at least one part of the ink-transferring sections 32 and 42 which extends in the circumferential direction interacts, ink being transferred from the softer surface of the section 32 onto the harder surface of the section 42 by ink splitting.

The ink-transferring section 32 of the cylinder 30 and the ink-transferring section 42 of the cylinder 40 can be phase-shifted with respect to one another, that is to say the circumferential region of the sections 32, 42 which come into contact with one another can be set.

The cylinders 30 and 40 preferably have the same diameter.

Accordingly, the contact region can therefore be varied between a state, in which there is no phase difference between the two cylinders 30, 40 and the circumferential extents of the sections 32, 42 correspond exactly to one another (full ink transfer), and a state, in which the outer surfaces of the sections 32, 42 do not come into contact with one another at all (no ink transfer), in the case of a phase shift of 90° in the example which is shown. If the section 42 comes into contact with the section 34, no ink is transferred from the roller 30 onto the roller 40.

As each cylinder 30, 40 has only a single ink-transferring section which covers half the cylinder circumference, a phase shift by 180° is necessary, in order to achieve full contact.

FIG. 1 therefore shows the state, in which there is no phase shift, the cylinder 40 moving in a direction D3 and the section 42 interacting with the section 32 of the cylinder 30 along its entire circumferential extent. In this way, ink is transferred from the section 32 onto the section 42. The cylinder 40 can interact with an inking unit roller 50 which rotates in a direction D4 and has, for example, a rubber surface for further transfer of the ink.

As is shown, some ink 37 remains on the section 32 even after complete transfer onto the section 42. The section 42 receives an ink film 47 and transfers the latter partially as an ink film 57 onto the roller 50. The inking unit roller 50 can interact with a further inking unit roller 59 which makes contact with an image carrier, for example a plate cylinder.

An angle α which lies between the metering gap of the pre-metering device 12 and the common contact point of the feed roller 20 and the cylinder 30 can be approximately 90°, which is advantageous with regard to minimizing the influence of startup disruptions caused at the contact point on the ink layer thickness which is produced in the metering gap.

Furthermore, rotational axes 51, 52, 53 of the feed roller 20 and the cylinders 30, 40 can lie on a straight line, in a deviation from the example which is shown in the drawing, with the result that the same amount of time is advantageously available for accelerating and for retarding the cylinder 30.

FIG. 2 shows the same embodiment as FIG. 1, in the case of a phase shift of 45° between the section 42 of the cylinder 40 and the section 32 of the cylinder 30. In the case of this phase shift, only half as much ink is transferred from the section 32 onto the section 42 as in the case of the state which is shown in FIG. 1 without a phase shift. As can be seen, a thicker ink film 39 remains partially on the section 32, as the section 32 has not come into contact with the contact section 42 at this location. Very precise ink transfer, that is to say control of the transferred ink amount from the section 32 onto the section 42, can be achieved by a controlled change in the phase shift. As a result, the ink amount which is to be transferred by the overall inking unit onto an image carrier can be metered exactly.

As an alternative to the raised sections 32, 42 which are shown, the rotating apparatuses 30, 40 can also have oleophilic and oleophobic outer surfaces with the same diameter such that they follow one after another.

The establishment of the ink guidance by the surface properties (oleophilic, oleophobic) has the advantage that the apparatuses 30, 40 are simpler to clean.

As shown in FIG. 2, the first cylinder 30 is driven rotationally by an electric motor 54, and the motor 54 is actuated by an electronic control device 55. The control device 55 actuates the motor 54 in such a way that the latter and therefore also the first cylinder 30 are accelerated and retarded periodically.

During this non-uniform rotational movement of the first cylinder 30, the feed roller 20 and the second cylinder 40 rotate in each case at a uniform speed, the second cylinder 40 rotating at the machine speed and the feed roller 20 rotating at a speed which lies substantially below the machine speed. The particularly low rotational speed of the feed roller 20 is advantageous with regard to a reduced dependency on the rheological properties of the transferred fluid, which is printing ink. Furthermore, it is advantageous with regard to avoiding the inclusion of air into this printing ink which causes small bubbles and foam and with regard to reducing the hydrodynamic forces which act on the pre-metering device 12 and impair its metering accuracy.

The second cylinder 40 is driven by an non-illustrated electric motor which is different than the motor 54 and can be a main drive of the printing press. The feed roller 20 is driven by an electric motor which is different than the motor 54 and can likewise be the main drive of the printing press or a separate drive instead.

What is known as the revolution rate of the first cylinder 30 can be preselected at the control device 55, that is to say the setting can be made thereon concerning the number of revolutions of a printing form cylinder of the printing press, per which the first cylinder 30 executes one full revolution. For example, the setting can be selected in such a way that the first cylinder 30 executes one revolution per revolution of the printing form cylinder, or per in each case two revolutions (half revolution rate) or per in each case three revolutions (⅓ revolution rate), etc. It is therefore advantageously possible to adapt the amount of transfer fluid to the print job by a selection of a revolution rate of the first cylinder 30 which is suitable for the respective print job. For example, the half revolution rate can be selected for a print job having a relatively high ink requirement, and the ⅓ revolution rate can be selected for a print job having a relatively low ink requirement.

The speed profile, according to which the motor 54 accelerates and retards the first cylinder 30 periodically during continuous printing operation, is selected in such a way that the ink-transferring section 32, during its contact with the feed roller 20, has at least approximately, and preferably precisely, the circumferential surface speed of the latter. The ink-transferring section 32 is shown in the drawing with an uninterrupted solid line in its rotational position which corresponds to the contact with the feed roller 20.

After the ink-transferring section 32 has received the printing ink from the feed roller 20, the first cylinder 30 is accelerated to machine speed, with the result that the ink-transferring section 32, during its subsequent contact with the ink-transferring section 42 of the second cylinder 40, rotates at least approximately, and preferably precisely, the circumferential surface speed of the ink-transferring section 42 of the second cylinder 40. FIGS. 1 and 2 show the sections 32, 42 during their rolling contact with one another with an interrupted phantom line.

After the ink-transferring section 32 of the first cylinder 30 has transferred the printing ink onto the second cylinder 40, the first cylinder 30 is retarded again, until it has again reached the speed, at which no slip or at least almost no slip occurs between the ink-transferring section 32 of the first cylinder 30 and the feed roll 20 during the repeated ink receiving of the first cylinder 30.

These acceleration and retardation phases are repeated cyclically, in accordance with the revolution rate of the first cylinder 30 which is preselected for example in the form of a command of a control program which runs in the control device 55.

I claim:

1. An apparatus for controlling an amount of fluid to be transferred, the apparatus comprising:
a first rotating device having a first fluid-transferring section in a circumferential direction;
a second rotating device having a second fluid-transferring section in a circumferential direction; and
a control device for setting a phase position between said first fluid-transferring section and said second fluid-transferring section, said control device configured for accelerating and retarding a rotation of said first rotating device periodically.

2. The apparatus according to claim 1, wherein:
said first rotating device has a first non-fluid-transferring section adjoining said first fluid-transferring section in the circumferential direction; and
said second rotating device has a second non-fluid-transferring section adjoining said second fluid-transferring section in the circumferential direction.

3. The apparatus according to claim 2, wherein said first and second fluid-transferring sections and said first and second non-fluid-transferring sections in each case have a same sheet length.

4. The apparatus according to claim 2, wherein at least one of said first fluid-transferring section and said second fluid-transferring section is formed from an elastically deformable material.

5. The apparatus according to claim 4, wherein said elastically deformable material has a cutout formed therein and at least one of said first non-fluid-transferring section and said second non-fluid-transferring section is formed by said cutout disposed in said elastically deformable material.

6. The apparatus according to claim 2, wherein at least one of said first fluid-transferring section and said second fluid-transferring section is formed from a substantially dimensionally stable material.

7. The apparatus according to claim 6, wherein said substantially dimensionally stable material has cutout formed therein and at least one of said first non-fluid-transferring section and said second non-fluid-transferring section is formed by said cutout disposed in said substantially dimensionally stable material.

8. The apparatus according to claim 2, wherein:
at least one of said first fluid-transferring section and said second fluid-transferring section has a surface for revecing the fluid; and
at least one of said first non-fluid-transferring section and said second non-fluid-transferring section has a surface which does not receive or rejects the fluid.

9. The apparatus according to claim 1, wherein said first rotating device forms a transfer nip with said second rotating device.

10. The apparatus according to claim 1, wherein at least one of said first rotating device and said second rotating device is selected from the group consisting of rollers and cylinders.

11. The apparatus according to claim 1, wherein the fluid to be transferred is selected from the group consisting of printing ink, dampening solution and varnish.

12. The apparatus according to claim 4, wherein said elastically deformable material is selected from the group consisting of rubber and a rubber-like material.

13. The apparatus according to claim 6, wherein said substantially dimensionally stable material is selected from the group consisting of metal, plastic and ceramic.

14. The apparatus according to claim 8, wherein:
said surface of at least one of said first fluid-transferring section and said second fluid-transferring section for revecing the fluid is oleophilic; and
said surface of at least one of said first non-fluid-transferring section and said second non-fluid-transferring section which does not receive or rejects the fluid is one of oleophobic and hydrophilic.

15. The apparatus according to claim 9, wherein said first fluid-transferring section forms a synchronized transfer nip with said second fluid-transferring section.

16. An inking unit, comprising:
an apparatus for controlling an amount of fluid to be transferred, the apparatus including:
a first rotating device having a first fluid-transferring section in a circumferential direction;
a second rotating device having a second fluid-transferring section in a circumferential direction; and
a control device for setting a phase position between said first fluid-transferring section and said second fluid-transferring section, said control device configured for accelerating and retarding a rotation of said first rotating device periodically.

17. A dampening unit, comprising:
an apparatus for controlling an amount of fluid to be transferred, the apparatus including:
a first rotating device having a first fluid-transferring section in a circumferential direction;
a second rotating device having a second fluid-transferring section in a circumferential direction; and
a control device for setting a phase position between said first fluid-transferring section and said second fluid-transferring section, said control device configured for accelerating and retarding a rotation of said first rotating device periodically.

18. A machine which processes printing material, comprising:
an apparatus for controlling an amount of fluid to be transferred, the apparatus including:
a first rotating device having a first fluid-transferring section in a circumferential direction;
a second rotating device having a second fluid-transferring section in a circumferential direction; and
a control device for setting a phase position between said first fluid-transferring section and said second fluid-transferring section, said control device configured for accelerating and retarding a rotation of said first rotating device periodically.

19. A method for controlling an amount of fluid to be transferred, which comprises the steps of:
applying a fluid onto a first rotating device having a first fluid-transferring section in a circumferential direction;
transferring at least one portion of the fluid onto a second rotating device having a second fluid-transferring section in a circumferential direction;
controlling the at least one portion by setting a phase position between the first fluid-transferring section and the second fluid-transferring section; and
accelerating and retarding periodically a rotation of the first rotating device.

20. The method according to claim 19, which further comprises setting an overlapping sheet length of the first fluid-transferring section and the second fluid-transferring section.
